(19) United States
(12) Patent Application Publication
(10) Pub. No.: US 2020/0062081 A1
(43) Pub. Date: Feb. 27, 2020

(54) Vehicle Alarm System

(71) Applicant: Carlos Miguel Curry, Chicago, IL (US)

(72) Inventor: Carlos Miguel Curry, Chicago, IL (US)

(21) Appl. No.: 16/550,168

(22) Filed: Aug. 23, 2019

Related U.S. Application Data
(60) Provisional application No. 62/722,151, filed on Aug. 23, 2018.

(51) Int. Cl. B60H 1/00; G07C 5/00; B60Q 5/00; G07C 9/00

(52) U.S. Cl. CPC B60H 1/00964; G07C 5/008; G07C 9/00119; B60H 1/00735; B60Q 5/005

(57) ABSTRACT

A vehicle alarm system is disclosed herein. The vehicle alarm system includes a processor configured to be electrically coupled to a vehicle, and an alert application on a mobile device of an individual. The alert application is electrically coupled to the processor. The processor is configured to be coupled to an engine of the vehicle such that when the vehicle engine is turned off, the processor is configured to send an alert notification to the alert application to prompt the individual to deactivate the vehicle alarm system. If the individual does not deactivate the vehicle alarm system within predetermined time periods, certain events (e.g., notifying authorities, lowering windows of the vehicle, and/or activating a speaker, light-emitting device, and/or cooling fan) will occur. The present disclosure also provides methods of preventing overheating of a passenger in a vehicle using the vehicle alarm system.

### CROSS-REFERENCE TO RELATED APPLICATIONS

This application claims the benefit of U.S. Provisional Application No. 62/722,151, filed Aug. 23, 2018, the contents of which are incorporated herein by reference.

### TECHNICAL FIELD

This disclosure relates generally to alarm systems, and more particularly, to vehicle alarm systems. This disclosure also relates to methods of preventing overheating of a passenger in a vehicle using such an alarm system. The passenger can be, e.g., a child or a pet.

### BACKGROUND

Individuals may inadvertently leave a passenger (e.g., a child or pet) in a vehicle. This can happen, for example, if the individual is in a hurry, or if the passenger is asleep in a back seat of the vehicle. In some cases, an individual may choose to leave a passenger in a vehicle for a brief period of time, e.g., while running an errand. Whatever the scenario, any instance of leaving a passenger alone in an enclosed vehicle can create health and safety issues for the passenger. This is because it only takes a short period of time for the temperature inside a car, even with the windows cracked, to rise to dangerous levels. As a result, leaving a passenger alone in a vehicle can lead to tragic circumstances, particularly on hot days.

As set forth in the present disclosure, it would be desirable to provide a vehicle alarm system that overcomes one or more disadvantages of conventional vehicle alarm systems known in the prior art. In some embodiments, the present invention overcomes some disadvantages by providing a vehicle alarm system in which one or more cooling events and/or alerting events occurs after a particular period of time has elapsed. Certain embodiments of the present invention provide that the vehicle alarm system is automatically activated when a vehicle engine is turned off. In addition or alternatively, the vehicle alarm system of the present invention can include an alert application on a mobile device of an individual. In some embodiments, when the vehicle engine is turned off, an alert notification is sent to the alert application to prompt the individual to deactivate the vehicle alarm system.

### SUMMARY

The present invention provides a security safety alarm system that is specially designed for use in automobiles. While most adults would never willfully put their loved ones at risk, the present invention provides a way to avoid the accidental leaving of a passenger in a hot, enclosed vehicle after the vehicle engine has been turned off.

The present invention is able to activate in a matter of seconds, which provides the individual with a clear reminder (e.g., both visually and audibly) that he or she must immediately return to the vehicle to retrieve the passenger. Advantageously, the alert to the individual can be provided through a mobile application, thus providing a notification unit that is readily accessible. Moreover, the audible and visible warnings of the present alarm system, coupled with activation of cooling fans and lowering of vehicle windows, help ensure that the vehicle passenger (e.g., child or pet) is safe from overheating.

Certain embodiments of the present invention provide a vehicle alarm system. The vehicle alarm system comprises a processor, and an alert application electrically coupled to the processor. The alert application is on a mobile device of an individual. The processor is configured to be electrically coupled to an engine of a vehicle such that when the engine of the vehicle is turned off, the processor is configured to send an alert notification to the alert application so as to prompt the individual to deactivate the vehicle alarm system. The vehicle alarm system further includes at least one of a speaker and a light-emitting device electrically coupled to the processor. If the individual does not deactivate the vehicle alarm system within a first predetermined period of time, the at least one of the speaker and the light-emitting device is activated. The speaker is configured to provide an audible warning, and the light-emitting device is configured to provide a visual warning.

In some embodiments, the invention provides a method of preventing overheating of a passenger in a vehicle. The method can comprise the step of providing a vehicle having an engine, as well as the step of providing a vehicle alarm system. The vehicle alarm system can comprise a processor, a speaker, and a light-emitting device each electrically coupled to the vehicle. The vehicle alarm system can include an alert application that is electrically coupled to the processor. The alert application is on a mobile device of an individual. The method can comprise the step of sending an alert notification to the alert application to prompt the individual to deactivate the vehicle alarm system after the vehicle engine is turned off. If the individual does not deactivate the vehicle alarm system within a first predetermined period of time, the method can comprise the step of activating one or both of the speaker and the light-emitting device. The speaker is configured to provide an audible warning, and the light-emitting device is configured to provide a visual warning.

Inventive principles described herein may be incorporated into a variety of different vehicle alarm configurations. The details of one or more examples are set forth in the accompanying drawings and the description below. Other features, objects, and advantages will be apparent from the description and drawings.

### BRIEF DESCRIPTION OF DRAWINGS

The following drawings are illustrative of particular embodiments of the present invention and therefore do not limit the scope of the invention. The drawings are not necessarily to scale (unless so stated) and are intended for use in conjunction with the explanations in the following description. Embodiments of the invention will hereinafter be described in conjunction with the appended drawings, wherein like numerals denote like elements.

FIG. 1 is a schematic depiction of an illustrative vehicle alarm system of the present disclosure.

FIG. 2 is a flow chart of an illustrative method of preventing overheating of a passenger in a vehicle.

### DETAILED DESCRIPTION

The following detailed description is exemplary in nature and is not intended to limit the scope, applicability, or configuration of the invention in any way. Rather, the following description provides some practical illustrations for implementing exemplary embodiments of the present invention. Examples of constructions, materials, and/or dimensions are provided for selected elements. Those skilled in the art will recognize that many of the noted examples have a variety of suitable alternatives.

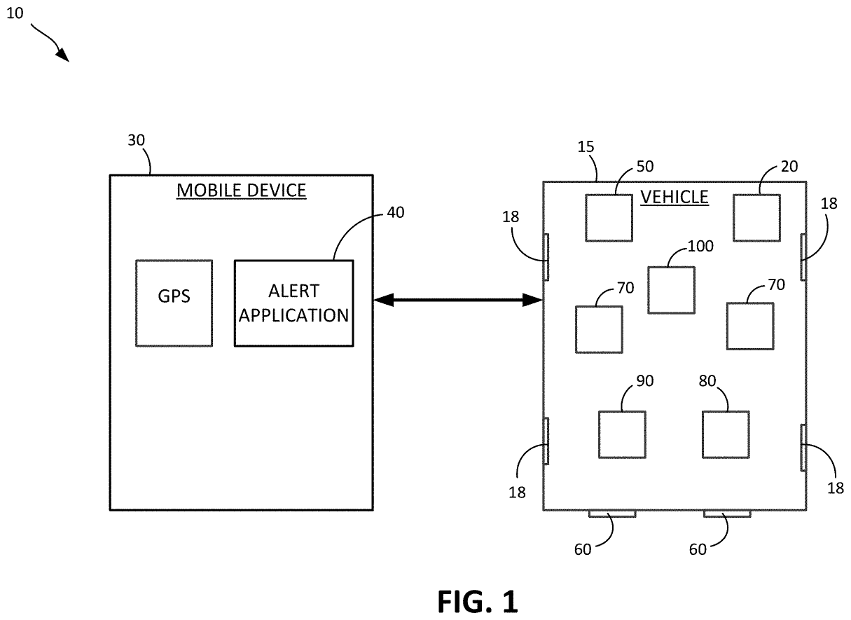

FIG. 1 is a schematic depiction of a vehicle alarm system 10. Vehicle alarm system 10 is specially designed to alert a person (e.g., a driver of a motor vehicle) that a vehicle 15 may be occupied. In this manner, the present invention is intended to prevent the person from inadvertently leaving a passenger (e.g., a child or pet) in the vehicle 15 so as to prevent overheating of the passenger. As used herein, the term passenger can refer to a person or a pet.

Vehicle alarm system 10 is used in conjunction with a mobile device 30 of an individual. Mobile device 30 may include smartphones, tablets, computers, and other suitable mobile devices. Mobile device 30 may include various components or features. Such components or features may include hardware, software, and combinations thereof. The scope of components and features on a mobile device will be recognized by those skilled in the art. Mobile device 30 may include system software, such as an operating system or firmware. In some embodiments, mobile device 30 includes an alert application 40.

A processor 20 is electrically coupled to the alert application 40. The processor 20 can be mounted in the vehicle 15, e.g., underneath a dashboard of the vehicle. In some cases, the processor 20 is an integrated circuit (e.g., a microchip). This, however, is not required in all embodiments.

The processor 20 is electrically coupled to an engine of the vehicle 15 such that when the vehicle engine is turned off, the processor 20 is configured to send an alert notification to the alert application 40. The alert notification notifies (i.e., prompts) the individual to deactivate the vehicle alarm system 10. If the individual did not leave a passenger in the vehicle 15, the individual should deactivate the vehicle alarm system 10 upon receiving the alert notification. The alert application 40 can also provide an audible warning or command to the individual to further prompt the individual to deactivate the alarm system 10.

If the individual does not deactivate the vehicle alarm system 10 within a certain period of time (e.g., within 30 seconds after turning off the vehicle engine), the vehicle alarm system 10 will cause one or more cooling events and/or alerting events to occur. The one or more cooling events are configured to cool an interior of the vehicle so as to prevent overheating of a passenger left in the vehicle 15. The one or more alerting events are configured to notify the individual or a third party that a passenger has been left in the vehicle 15.

As discussed above, the cooling events and alerting events occur based on whether the individual has or has not deactivated the vehicle alarm system 10 within a particular period of time. As a result, when the individual does not deactivate the vehicle alarm system 10 quickly enough, one or more alerting events and/or cooling events may occur even if no passenger was left in the vehicle 15. This provides the vehicle alarm system 10 of the present invention with an added safety precaution by forcing the individual to deactivate the vehicle alarm system 10 each time after turning off the vehicle engine. Thus, where the individual fails to deactivate the system 10 (e.g., when the individual's mobile device is not working, or when the individual leaves his or her mobile device in the vehicle), one or more alerting events and/or cooling events will occur.

In some embodiments, a speaker 50 is provided that is electrically coupled to the processor 20. If the individual does not deactivate the vehicle alarm system 10 within a certain time period (e.g., a first predetermined period of time), the speaker 50 is configured to provide an audible warning. In some cases, the speaker 50 comprises a horn of the vehicle 15, and activating the speaker causes the vehicle horn to honk.

In other cases, the speaker 50 is a part of the vehicle's audio system. Activating such a speaker may deliver a vocal warning, such as “BABY LEFT IN BACK SEAT!” The vehicle alarm system 10 can include one or both of the vehicle horn and the vehicle's audio system. In embodiments where both types of speakers 50 are provided, the speakers can be either simultaneously or sequentially activated.

The first predetermined period of time is a short time period (e.g., within 18-30 seconds) after the vehicle has been turned off. The short time period provides a way to notify the individual (e.g., with audible and/or visible alerts emitted from the vehicle) while the individual is still within sight and sound of the vehicle.

In some embodiments, the vehicle alarm system 10 includes a light-emitting device 60 electrically coupled to the processor 20. If the individual does not deactivate the vehicle alarm system 10 within a certain time period (e.g., within the first predetermined period of time), the light-emitting device 60 is configured to be activated so as to provide a visual warning. In some cases, activating the light-emitting device 60 causes the light-emitting device to turn on and providing a flashing light. The light-emitting device 60 can comprise a single light-emitting device or can comprise two or more light-emitting devices. In some embodiments, the light-emitting device 60 comprises one or more lights of the vehicle (e.g., headlights or taillights of the vehicle). Activating the light-emitting device 60 and activating the speaker 50 both constitute alerting events of vehicle alarm system 10.

In certain embodiments, the vehicle alarm system 10 includes one or more cooling fans 70 configured to be mounted in the vehicle 15. In such embodiments, if the individual does not deactivate the vehicle alarm system 10 within a second predetermined period of time, the processor 20 is configured to activate the one or more cooling fans 70 so as to circulate cooled air within the vehicle 15. In some cases, the second predetermined period of time is longer than the first predetermined period of time, such that the one or more cooling fans 70 are activated only after the light-emitting device 60 and/or speaker 50 is activated. In certain embodiments, the one or more cooling fans are part of an air conditioning unit of the vehicle 15. For example, in some embodiments, the one or more cooling fans 70 are mounted behind the headliner (i.e., the ceiling line of the vehicle) so that the one or more cooling fans 70 are concealed from view.

In some embodiments, the processor 20 is configured to be electrically coupled to windows 18 of the vehicle 15. In embodiments of this nature, if the individual does not deactivate the vehicle alarm system 10 within the second predetermined period of time, the processor 20 is configured to activate the windows 18 so as to move the windows 18 from a closed position to an open position. When activated, the windows 18 can be lowered about one-and-a-half to three inches. Lowering the vehicle windows 18 and activating the one or more cooling fans 70 represent different cooling events of vehicle alarm system 10. In certain embodiments of the present disclosure, either or both types of cooling events can occur.

Since the speaker 50, light-emitting device 60, cooling fan(s) 70, and windows 18 are all components of the vehicle 15, the processor 20 simply needs to be linked to the appropriate wiring of the vehicle (e.g., wiring that controls the lights, horn, windows, audio system, and/or air conditioning of the vehicle).

The vehicle alarm system 10 can also include a camera 80 that is located (e.g., mounted) in the vehicle 15. The camera 80 is electrically coupled to the processor 20. The camera 80 is configured to capture video of the passenger, which video is then transmitted from the camera 80 to the mobile device 30. Thus, when the video alarm system 10 is activated, the individual is able to watch video of the vehicle passenger via the alert application 40.

In some cases, the vehicle alarm system 10 includes a microphone 90. The microphone 90 can be provided instead of, or in addition to, the camera 80. In some cases, the microphone 90 and the camera 80 are provided as a single device. The microphone 90 is configured to capture audio input from the passenger, which audio input is then transmitted from the microphone 90 to the mobile device 30. Thus, when the video alarm system 10 is activated, the individual is able to listen to audio input from the interior of the vehicle 15.

A camera of the mobile phone 30 is configured to capture video of the individual while the vehicle alarm system 10 is activated. Similarly, a microphone of the mobile phone 30 is configured to capture audio input from the individual while the vehicle alarm system 10 is activated. The video and the audio input from the individual is configured to be transmitted to the camera 80 and the microphone 90 of the vehicle alarm system 10, respectively, so as to provide a two-way communication system between the passenger and the individual when the vehicle alarm system 10 is activated.

In some cases, if the individual does not deactivate the vehicle alarm system 10 within a third predetermined period of time, the alert application 40 sends an alert signal to a third party authority, such as On-Star, the police, or another emergency responder. The alert signal provides the third party authority with locational information (e.g., GPS data) of the vehicle 15. This allows the third party authority to be notified, and then to locate and rescue any passenger that may have been left in the vehicle 15. The third predetermined period of time can be a period of time that is longer than either of the second predetermined period of time or the first predetermined period of time. In such cases, the third party authority is notified only if the other alert mechanisms of vehicle alarm system 10 have not been successful in getting the individual to deactivate the vehicle alarm system 10.

Testing can be routinely performed to ensure that the vehicle alarm system 10 works as intended. For example, such testing can be performed along with routine maintenance checks and/or vehicle emissions tests of the vehicle 15.

In certain embodiments, the vehicle alarm system 10 includes a motion detector 100 configured to detect motion in an interior of the vehicle 15 after the vehicle 15 has been turned off. Once the motion detector 100 detects such motion in the vehicle 15, the individual is notified by the alert application 40. This occurs even when the individual has not affirmatively activated the alarm system 10 prior to driving such that the alarm system 10 is designed to work any time the vehicle is turned off. If the user does not deactivate the system 10 within a particular period of time after receiving the alert notification, any one or more of the light-emitting device 60, the windows 18, the cooling fan(s) 70, the camera 80, the microphone 90, and the speaker 50 can be activated. In addition, as discussed above, the alert application 40 can notify a third party authority if the vehicle alarm system 10 is not deactivated within a certain period of time. The vehicle alarm system 10 will remain activated until it is affirmatively deactivated.

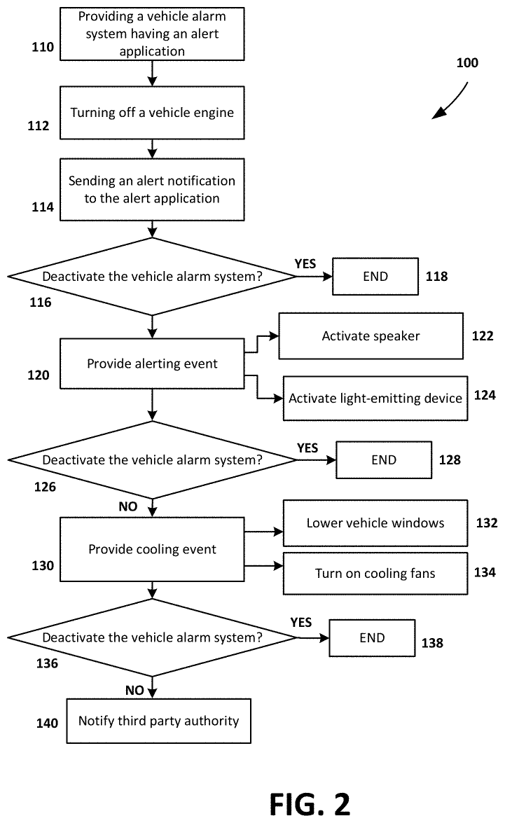

An illustrative method 100 of preventing overheating of a passenger in a vehicle is shown in FIG. 2. The method 100 can comprise the step 110 of providing a vehicle alarm system. The vehicle alarm system can have the same or similar characteristics as the vehicle alarm system described elsewhere herein.

The method 100 can also include the step 112 of turning off an engine of a vehicle having the vehicle alarm system. In some embodiments (e.g., in embodiments where the vehicle alarm system 10 includes an alert application), the method 100 can include the step 114 of sending an alert notification to the alert application to prompt the individual to deactivate the vehicle alarm system. This step can occur shortly after, or at the same time, that the vehicle engine is turned off.

The method 100 can also include the step 116 of determining whether the vehicle alarm system was deactivated within a particular period of time (e.g., within a certain time period after sending the alert notification at step 114). If the vehicle alarm system was deactivated within the relevant time period, the method 100 may end at step 118. If the vehicle alarm system has not been deactivated within the predetermined period of time, the method 100 can provide one or more alerting events (step 120). In some cases, providing the alerting event 120 can involve activating a speaker (e.g., a horn or a vocal announcement) to provide an audible warning (step 122). In addition or alternatively, providing the alerting event 120 can involve activating a light-emitting device (e.g., flashing lights) so as to provide a visual warning (step 124).

The method 100 can also include a step 126 of determining whether the vehicle alarm system was deactivated within a particular period of time. In some cases, this is based on a predetermined period of time after the alerting event was initiated. If the vehicle alarm system was deactivated within that predetermined time period, the method 100 may end at step 128. If the vehicle alarm system has not been deactivated within the predetermined time period, the method 100 can provide one or more cooling events (step 130). Providing the cooling event(s) can involve the step 132 of lowering windows of the vehicle.

In addition or alternatively, providing the cooling event can involve turning on the vehicle engine, as well as the step 134 of turning on the cooling fans (e.g., air conditioning) in the vehicle. This will provide the passenger with cooled air until the driver returns to, or a third party reaches, the vehicle. Step 134 will often be used with higher-end vehicles (e.g., Mercedes Benz, Bentley, Aston Martin, and Rolls Royce), as opposed to lower-end vehicles. This is because the air conditioning units of lower-end vehicles may become faulty and cause the vehicle to heat up, possibly leading to the same fatal conditions the present alarm system is designed to prevent.

The method 100 can also include the step 136 of determining whether the vehicle alarm system was deactivated within a particular period of time. In some cases, this is based on a predetermined period of time after the cooling event was initiated. If the vehicle alarm system was deactivated within the relevant time period, the method 100 may end at step 138. If the vehicle alarm system has not been deactivated within the predetermined period of time, the method 100 can comprise the step 140 of sending, via the alert application, an alarm signal (e.g., a wireless alarm signal) to a third party authority, such as On-Star, the police, or another emergency responder.

Various examples have been described with reference to certain disclosed embodiments. The embodiments are presented for purposes of illustration and not limitation. One skilled in the art will appreciate that various changes, adaptations, and modifications can be made without departing from the scope of the invention.

1. A vehicle alarm system comprising:
a processor;
an alert application electrically coupled to the processor, the alert application being on a mobile device of an individual, the processor being configured to be electrically coupled to an engine of a vehicle such that when the engine of the vehicle is turned off, the processor is configured to send an alert notification to the alert application to prompt the individual to deactivate the vehicle alarm system; and
at least one of a speaker and a light-emitting device electrically coupled to the processor;
wherein if the individual does not deactivate the vehicle alarm system within a first predetermined period of time, the at least one of the speaker and the light-emitting device is activated by the processor, wherein the speaker is configured to provide an audible warning when activated by the processor, and the light-emitting device is configured to provide a visual warning when activated by the processor.

2. The vehicle alarm system of claim 1 wherein the speaker comprises a vehicle horn.

3. The vehicle alarm system of claim 1 wherein the light-emitting device is configured to turn on and provide a flashing light when activated.

4. The vehicle alarm system of claim 1, further comprising one of more cooling fans, wherein if the individual does not deactivate the vehicle alarm system within a second predetermined period of time, the one or more cooling fans is activated by the processor, wherein the one or more cooling fans are configured to circulate cooled air within the vehicle when the one or more cooling fans are activated by the processor.

5. The vehicle alarm system of claim 1, wherein the processor is configured to be electrically coupled to windows of the vehicle, wherein if the individual does not deactivate the vehicle alarm system within a second predetermined period of time, the windows are activated by the processor so as to move the windows from a closed position to an open position.

6. The vehicle alarm system of claim 1, wherein the processor comprises a computer chip.

7. The vehicle alarm system of claim 4, wherein if the individual does not deactivate the vehicle alarm system within a third predetermined period of time, the alert application is configured to send a third alarm signal to a third party authority, wherein the third predetermined period of time is a period of time that is longer than either of the second predetermined period of time or the first predetermined period of time.

8. The vehicle alarm system of claim 5, wherein if the individual does not deactivate the vehicle alarm system within a third predetermined period of time, the alert application is configured to send a third alarm signal to a third party authority, wherein the third predetermined period of time is a period of time that is longer than either of the second predetermined period of time or the first predetermined period of time.

9. A vehicle alarm system comprising:
a vehicle having a plurality of windows and an engine;
a processor electrically coupled to the vehicle;
an alert application, the alert application being on a mobile device of an individual, the processor being electrically coupled to the alert application and being configured to be electrically coupled to an engine of the vehicle such that when the vehicle engine is turned off, the processor is configured to send an alert notification to the alert application to prompt the individual to deactivate the vehicle alarm system;
at least one of a speaker and a light-emitting device electrically coupled to the processor;
wherein if the individual does not deactivate the vehicle alarm system within a first predetermined period of time, the at least one of the speaker and the light-emitting device is activated by the processor, wherein the speaker is configured to provide an audible warning when activated by the processor, and the light-emitting device is configured to provide a visual warning when activated by the processor.

10. The vehicle alarm system of claim 9, further comprising one of more cooling fans mounted in the vehicle, wherein the processor is electrically coupled to the one or more cooling fans, wherein if the individual does not deactivate the vehicle alarm system within a second predetermined period of time, the one or more cooling fans are activated by the processor, wherein the one or more cooling fans are configured to circulate cooled air within the vehicle when the one or more cooling fans are activated by the processor.

11. The vehicle alarm system of claim 10, wherein the one or more cooling fans are part of an air conditioning unit of the vehicle.

12. The vehicle alarm system of claim 10, wherein the one or more cooling fans are mounted to an interior ceiling of the vehicle.

13. The vehicle alarm system of claim 9, wherein the processor is electrically coupled to the windows of the vehicle, wherein if the individual does not deactivate the vehicle alarm system within a second predetermined period of time, the windows of the vehicle are activated by the processor so as to move the windows from a closed position to an open position.

14. The vehicle alarm system of claim 10, wherein if the individual does not deactivate the vehicle alarm system within a third predetermined period of time, the alert application is configured to send a third alarm signal to a third party authority, wherein the third predetermined period of time is longer than both the second predetermined period of time and the first predetermined period of time.

15. The vehicle alarm system of claim 12, wherein the speaker comprises a horn of the vehicle.

16. The vehicle alarm system of claim 12, wherein when the light-emitting device is activated, the light emitting device is configured to turn on and provide a flashing light.

17. A method of preventing overheating of a passenger in a vehicle, comprising:
providing a vehicle having an engine;
providing a vehicle alarm system comprising:
a processor electrically coupled to the vehicle and the vehicle engine;
a speaker electrically coupled to the processor;
a light-emitting device electrically coupled to the processor;
an alert application, the alert application being on a mobile device of an individual, the processor being electrically coupled to the alert application; and
sending, via the processor, an alert notification to the alert application to prompt the individual to deactivate the vehicle alarm system after the engine of the vehicle is turned off;
wherein if the individual does not deactivate the vehicle alarm system within a first predetermined period of time, activating, via the processor, one or both of the speaker and the light-emitting device, wherein the speaker is configured to provide an audible warning when activated by the processor, and the light-emitting device is configured to provide a visual warning when activated by the processor.

18. The method of claim 17, wherein the vehicle has a plurality of windows, wherein the vehicle alarm system comprises a cooling fan electrically coupled to the processor, wherein if the individual does not deactivate the vehicle alarm system within a second predetermined period of time, activating, via the processor, one or both of the cooling fan and the windows, wherein the windows are moved from a closed position to an open position when the windows are activated, and the cooling fan is configured to circulate cooled air within the vehicle when the cooling fan is activated.

19. The method of claim 17, wherein if the individual does not deactivate the vehicle alarm system within a third predetermined period of time, the alert application sends an alarm signal to a third party authority.

20. The method of claim 17, wherein the vehicle alarm system is deactivated using the alert application.
